(19) United States
(12) Patent Application Publication
(10) Pub. No.: US 2025/0196361 A1
(43) Pub. Date: Jun. 19, 2025

(54) CONTROLLING A ROBOTIC MANIPULATOR FOR PACKING AN OBJECT

(71) Applicant: Ocado Innovation Limited, Hatfield (GB)

(72) Inventors: Silvia CRUCIANI, London (GB); Diogo ALMEIDA, London (GB)

(21) Appl. No.: 18/848,839

(22) PCT Filed: Mar. 29, 2023
(86) PCT No.: PCT/EP2023/058192

§ 371 Date: Sep. 19, 2024

(30) Foreign Application Priority Data
Mar. 31, 2022 (GB) 2204711.2

(51) Int. Cl. B25J 9/16; B25J 13/08

(52) U.S. Cl. CPC B25J 9/1697; B25J 9/1633; B25J 9/1687; B25J 13/082

(57) ABSTRACT

Controlling a Robotic Manipulator for Packing an Object Provided is a computer-implemented method of controlling a robotic manipulator for packing an object, involving obtaining an image of an object grasped by an end effector of the robotic manipulator and determining a major axis of the object in the image. A first object pose is determined wherein the major axis of the object is aligned with an axis of a receiving space. The robotic manipulator is controlled to manipulate the object to the first object pose above the receiving space and move the object from the first object pose down into the receiving space. In response to detecting by a force sensor a contact force above a predetermined force threshold at the end effector, the robotic manipulator is controlled to manipulate the object to a second object pose, above the receiving space, for initiating a further attempt to place the object in the receiving space.

### TECHNICAL FIELD

The present disclosure relates to robotic control systems, specifically systems and methods for use in packing objects into receptacles.

### BACKGROUND

Bin packing is a core problem in computer vision and robotics. The goal is to have a system with sensors and a robot to grip items using a suction gripper, parallel gripper, or other kind of robot end effector, and pack the items into a bin, e.g. a receptacle. The packing system may be combined with a bin picking system using the same or a different robot to first pick up the objects with random poses (positions/orientations) out of a different bin using the same or a different type of end effector.

There are issues with present systems, however, including a focus on planning and avoiding all contact during packing, and assuming only rigid objects are being packed. This means the systems are not practicable in real-world scenarios. For example, general purpose packing solutions typically do not take into consideration the specificity of the grocery packing problem. For example, packing algorithms should be able to cope with unexpected errors and have robustness when executing packing attempts in real-world scenarios.

### SUMMARY

There is provided a computer-implemented method of controlling a robotic manipulator for packing an object, the method comprising:
obtaining an image of an object grasped by an end effector of the robotic manipulator;
determining a major axis of the object in the image;
determining a first object pose wherein the major axis of the object is aligned with an axis of a receiving space; and
controlling the robotic manipulator to:
   manipulate the object to the first object pose above the receiving space;
   move the object from the first object pose down into the receiving space; and
   manipulate the object, in response to detecting by a force sensor a contact force above a predetermined force threshold at the end effector, to a second object pose above the receiving space for initiating a further attempt to place the object in the receiving space.

Also provided is a data processing apparatus comprising a processor configured to perform the method. Also provided is a computer program comprising instructions which, when the program is executed by a computer, cause the computer to carry out the method. Similarly, a computer-readable storage medium is provided which comprises instructions that, when executed by a computer, cause the computer to carry out the method.

Further provided is a robotic packing system comprising a robotic manipulator for packing an object and a controller for the robotic manipulator configured to:
obtain an image of an object grasped by an end effector of the robotic manipulator;
determine a major axis of the object in the image;
determine a first object pose wherein the major axis of the object is aligned with an axis of a receiving space; and
control the robotic manipulator to:
   manipulate the object to the first object pose above the receiving space;
   move the object from the first object pose down into the receiving space; and
   manipulate the object, in response to detecting by a force sensor a contact force above a predetermined force threshold at the end effector, to a second object pose above the receiving space for initiating a further attempt to place the object in the receiving space.

In general terms, this description introduces systems and methods to pack objects into receptacles, e.g. containers, using a robotic manipulator by aligning an object with the receptacle (based on imaging analysis) and iterating packing attempts (based on force feedback). A contact force threshold, which may include a torque threshold, means that the system is sensitive to forces which could damage the object being packed or the contents of the receptacle. For example, if a contact force/torque is detected which exceeds the set threshold, the packing attempt is aborted and the robotic manipulator is reinitiated for another packing attempt starting from a shifted initial pose.

Aligning the object with the receptacle reduces the chance of contact forces therebetween during the one or more packing attempts. However, unexpected contact forces can still occur, e.g. between the object and the receptacle contents, so iterating the packing attempts along a path of shifted initial poses can increase the chances of achieving a successful packing attempt, e.g. where the set force/torque threshold is not exceeded and the object is released into the receptacle. The iterative nature of the presented packing solution thus adds robustness to the algorithm, compared with known systems and methods, by being able to react to unexpected contacts and attempt a new pack execution at a modified initial position.

Overall, the present system and methods combine a proactive component, the aligner, which uses imaging analysis to propose an initial pose, and a reactive component, the iterative packer, which drives the robotic manipulator to make packing attempts. Together, the combined system improves the efficiency of achieving a successful packing attempt versus implementing one or the other component independently.

### BRIEF DESCRIPTION OF THE DRAWINGS

Embodiments will now be described by way of example only with reference to the accompanying drawings, in which like reference numbers designate the same or corresponding parts, and in which:

FIG. 1 is a schematic diagram of a robotic packing system according to an embodiment;

FIG. 2 is a schematic front view of a robotic packing system according to an embodiment;

FIG. 3A is a schematic perspective view from an overhead camera of the robotic packing system according to an embodiment;

FIG. 3B is a representation of a point cloud image corresponding to the perspective view from the overhead camera of FIG. 3A;

FIG. 4A is a representation of a point cloud image of an object isolated from the point cloud image of FIG. 3B;

FIG. 4B is a representation of a projection of the point cloud image of FIG. 4A into a two-dimensional plane; and

FIG. 5 shows a flowchart depicting a computer-implemented method of controlling a robotic manipulator for packing an object, according to an embodiment.

In the drawings, like features are denoted by like reference signs where appropriate.

### DETAILED DESCRIPTION

In the following description, some specific details are included in the following description to provide a thorough understanding of various disclosed embodiments. However, one skilled in the relevant art will recognise that embodiments may be practised without one or more of these specific details or with other methods, components, materials, etc. In some instances, well-known structures associated with gripper assemblies and/or robotic manipulators (such as processors, sensors, storage devices, network interfaces, workpieces, tensile members, fasteners, electrical connectors, mixers, and the like) are not shown or described in detail to avoid unnecessarily obscuring descriptions of the disclosed embodiments.

Unless the context requires otherwise, the word “comprise” and its variants like “comprises” and “comprising” are to be construed in this description and appended claims in an open, inclusive sense, i.e. as “including, but not limited to”.

Reference throughout this specification to “one”, “an”, or “another” applied to “embodiment” or “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification do not necessarily refer to the same embodiment. Furthermore, the particular features, structures, or characteristics may be combined in any suitable manner in one or more embodiments, examples, or implementations.

It should be noted that, as used in this specification and the appended claims, the used forms “a”, “an”, and “the” include plural referents unless the content clearly dictates otherwise. It should also be noted that the term “or” is generally employed in its sense including “and/or” unless the content clearly dictates otherwise.

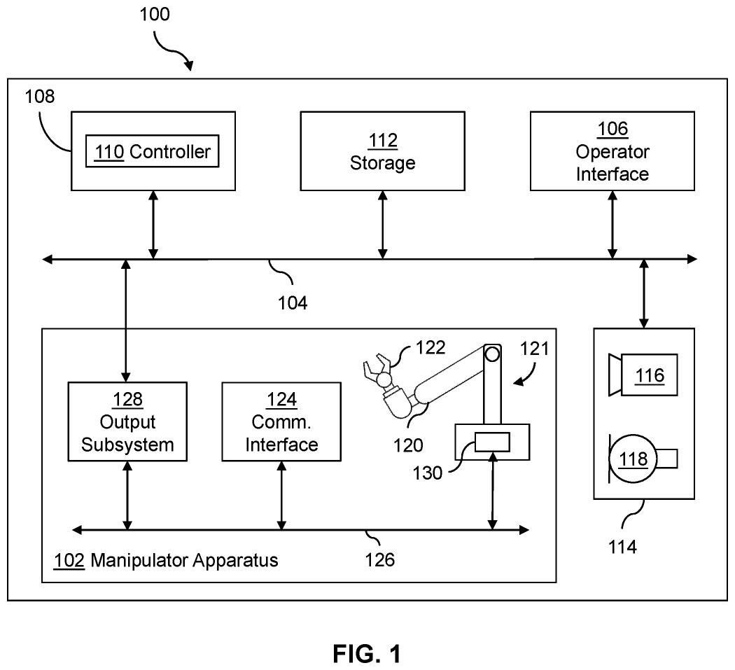

Regarding FIG. 1, there is illustrated an example of a robotic packing system 100 that may be adapted for use with the present assemblies, devices, and methods. The robotic packing system 100 may form part of an online retail operation, such as an online grocery retail operation. Still, it may also be applied to any other operation requiring the packing of items. For example, the robotic packing system 100 may also be adapted for picking or sorting articles, e.g. as a robotic picking/packing system sometimes referred to as a “pick and place robot”.

The robotic packing system 100 includes a manipulator apparatus 102 comprising a robotic manipulator 121. The manipulator 121 is an electro-mechanical machine comprising one or more appendages, such as a robotic arm 120, and an end effector 122 mounted on an end of the robotic arm 120. The end effector 122 is a device configured to interact with the environment in order to perform tasks, including, for example, gripping, grasping, releasably engaging or otherwise interacting with an item. Examples of the end effector 122 include a jaw gripper, a finger gripper, a magnetic or electromagnetic gripper, a Bernoulli gripper, a vacuum suction cup, an electrostatic gripper, a van der Waals gripper, a capillary gripper, a cryogenic gripper, an ultrasonic gripper, and a laser gripper.

The robotic manipulator 121 can grasp and manipulate an object. In the case of a pick and place application, the robotic manipulator 121 is configured to pick an item from a first location and place the item in a second location, for example.

The manipulator apparatus 102 is communicatively coupled via a communication interface 104 to other components of the robotic packing system 100, e.g. one or more optional operator interfaces 106 from which an observer may observe or monitor system 100 and the manipulator apparatus 102. The operator interfaces 106 may include a WIMP interface and an output display of explanatory text or a dynamic representation of the manipulator apparatus 102 in a context or scenario. For example, the dynamic representation of the manipulator apparatus 102 may include a video feed, for instance, a computer-generated animation. Examples of suitable communication interface 104 include a wire-based network or communication interface, an optical-based network or communication interface, a wireless network or communication interface, or a combination of wired, optical, and/or wireless networks or communication interfaces.

The example robotic packing system 100 also includes a control system 108, including at least one controller 110 communicatively coupled to the manipulator apparatus 102 and any other components of the robotic packing system 100 via the communication interface 104. The controller 110 comprises a control unit or computational device having one or more electronic processors. Embedded within the one or more processors is computer software comprising a set of control instructions provided as processor-executable data that, when executed, cause the controller 110 to issue actuation commands or control signals to the manipulator system 102. For example, the actuation commands or control signals cause the manipulator 121 to carry out various methods and actions, such as identifying and manipulating items.

The one or more electronic processors may include at least one logic processing unit, such as one or more microprocessors, central processing units (CPUs), digital signal processors (DSPs), graphics processing units (GPUs), application-specific integrated circuits (ASICs), programmable gate arrays (PGAs), programmed logic units (PLUS), or the like. In some implementations, the controller 110 is a smaller processor-based device like a mobile phone, single-board computer, embedded computer, or the like, which may be termed or referred to interchangeably as a computer, server, or analyser. The set of control instructions may also be provided as processor-executable data associated with the operation of the system 100 and manipulator apparatus 102 included in a non-transitory computer-readable storage device 112, which forms part of the robotic packing system 100 and is accessible to the controller 110 via the communication interface 104.

In some implementations, the storage device 112 includes two or more distinct devices. The storage device 112 can, for example, include one or more volatile storage devices, e.g. random access memory (RAM), and one or more non-volatile storage devices, e.g. read-only memory (ROM), flash memory, magnetic hard disk (HDD), optical disk, solid-state disk (SSD), or the like. A person of skill in the art will appreciate storage may be implemented in a variety of ways such as a read-only memory (ROM), random access memory (RAM), hard disk drive (HDD), network drive, flash memory, digital versatile disk (DVD), any other forms of computer- and processor-readable memory or storage medium, and/or a combination thereof. Storage can be read-only or read-write as needed.

The robotic packing system 100 includes a sensor subsystem 114 comprising one or more sensors that detect, sense or measure conditions or states of the manipulator apparatus 102 and/or conditions in the environment or workspace in which the manipulator 121 operates and produce or provide corresponding sensor data or information. Sensor information includes environmental sensor information, representative of environmental conditions within the workspace of the manipulator 121, as well as information representative of condition or state of the manipulator apparatus 102, including the various subsystems and components thereof, and characteristics of the item to be manipulated. The acquired data may be transmitted via the communication interface 104 to the controller 110 for directing the manipulator 121 accordingly. Such information can, for example, include diagnostic sensor information that is useful in diagnosing a condition or state of the manipulator apparatus 102 or the environment in which the manipulator 121 operates.

Such sensors include, for example, one or more cameras or imagers 116 (e.g. responsive within visible and/or non-visible ranges of the electromagnetic spectrum including, for instance, infrared and ultraviolet). The one or more cameras 116 may include a depth camera, e.g. a stereo camera, to capture depth data alongside colour channel data in an imaged scene. Other sensors of the sensor subsystem 114 may include one or more of: contact sensors, force sensors, strain gages, vibration sensors, position sensors, attitude sensors, accelerometers, radars, sonars, lidars, touch sensors, pressure sensors, load cells, microphones 118, meteorological sensors, chemical sensors, or the like. In some implementations, the sensors include diagnostic sensors to monitor a condition and/or health of an on-board power source within the manipulator apparatus 102 (e.g. a battery array, ultra-capacitor array, or fuel cell array).

In some implementations, the one or more sensors comprise receivers to receive position and/or orientation information concerning the manipulator 121. For example, a global position system (GPS) receiver to receive GPS data, two more time signals for the controller 110 to create a position measurement based on data in the signals, such as time-of-flight, signal strength, or other data to effect a position measurement. Also, for example, one or more accelerometers, which may also form part of the manipulator apparatus 102, could be provided on the manipulator 121 to acquire inertial or directional data, in one, two, or three axes, regarding the movement thereof.

The robotic manipulator 121 of the system 100 may be piloted by a human operator at the operator interface 106. In a human operator-controlled (or “piloted”) mode, the human operator observes representations of sensor data, e.g. video, audio, or haptic data received from the one or more sensors of the sensor subsystem 114. The human operator then acts, conditioned by a perception of the representation of the data, and creates information or executable control instructions to direct the manipulator 121 accordingly. In the piloted mode, the manipulator apparatus 102 may execute control instructions in real-time (e.g. without added delay) as received from the operator interface 106 without taking into account other control instructions based on the sensed information.

In some implementations, the manipulator apparatus 102 operates autonomously, i.e. without a human operator creating control instructions at the operator interface 106 for directing the manipulator 121. The manipulator apparatus 102 may operate in an autonomous control mode by executing autonomous control instructions. For example, the controller 110 can use sensor data from one or more sensors of the sensor subsystem 114. The sensor data is associated with operator-generated control instructions from one or more times during which the manipulator apparatus 102 was in the piloted mode to generate autonomous control instructions for subsequent use. For example, deep learning techniques can be used to extract features from the sensor data. Thus, in the autonomous mode, the manipulator apparatus 102 can autonomously recognise features or conditions of its environment and the item to be manipulated. In response, the manipulator apparatus 102 performs one or more defined acts or tasks. For example, the manipulator apparatus 102 performs a pipeline or sequence of acts or tasks.

In some implementations, the controller 110 autonomously recognises features or conditions of the environment surrounding the manipulator 121 and one or more virtual items composited into the environment. The environment is represented by sensor data from the sensor subsystem 114. In response to being presented with the representation, the controller 110 issues control signals to the manipulator apparatus 102 to perform one or more actions or tasks.

In some instances, the manipulator apparatus 102 may be controlled autonomously at a given time while being piloted, operated, or controlled by a human operator at another time. That is, the manipulator apparatus 102 may operate under the autonomous control mode and change to operate under the piloted (i.e. non-autonomous) mode. In another mode of operation, the manipulator apparatus 102 can replay or execute control instructions previously carried out in the piloted mode. That is, the manipulator apparatus 102 can operate based on replayed pilot data without sensor data.

The manipulator apparatus 102 further includes a communication interface subsystem 124 (e.g. a network interface device) communicatively coupled to a bus 126 and which provides bi-directional communication with other components of the system 100 (e.g. the controller 110) via the communication interface 104. The communication interface subsystem 124 may be any circuitry effecting bidirectional communication of processor-readable data and processor-executable instructions, such as radios (e.g. radio or microwave frequency transmitters, receivers, transceivers) ports, and/or associated controllers. Suitable communication protocols include FTP, HTTP, Web Services, SOAP with XML, cellular (e.g. GSM, CDMA), Wi-Fi® compliant, Bluetooth® compliant, and the like.

The manipulator apparatus 102 further includes a motion subsystem 130, communicatively coupled to the robotic arm 120 and end effector 122. The motion subsystem 130 comprises one or more motors, solenoids, other actuators, linkages, drive-belts, or the like operable to cause the robotic arm 120 and/or end effector 122 to move within a range of motions in accordance with the actuation commands or control signals issued by the controller 110. The motion subsystem 130 is communicatively coupled to the controller 110 via the bus 126.

The manipulator apparatus 102 also includes an output subsystem 128 comprising one or more output devices, such as speakers, lights, or displays that enable the manipulator apparatus 102 to send signals into the workspace to communicate with, for example, an operator and/or another manipulator apparatus 102.

A person of ordinary skill in the art will appreciate the components in manipulator apparatus 102 may be varied, combined, split, omitted, or the like. In some examples, one or more of the communication interface subsystem 124, the output subsystem 128, and the motion subsystem 130 are combined. In other instances, one or more subsystems (e.g. the motion subsystem 130) are split into further subsystems.

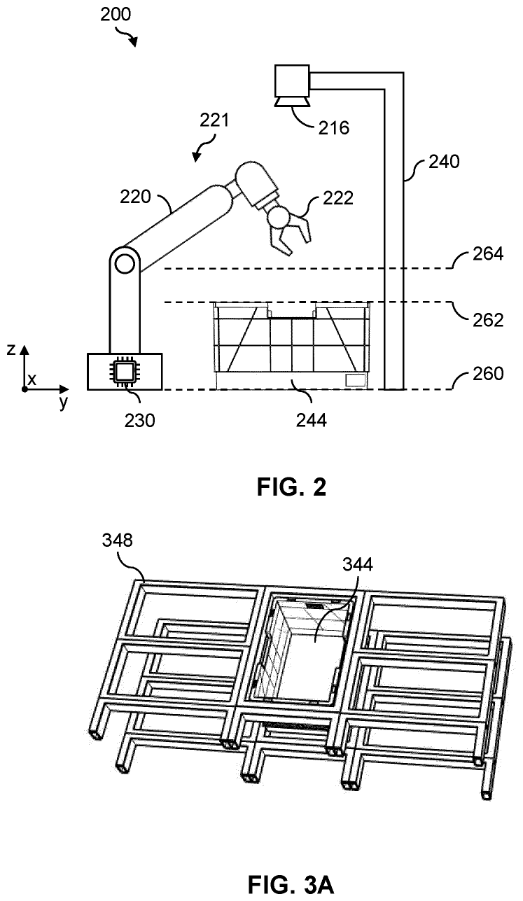

FIG. 2 shows an example of a robotic packing system 200 including a robotic manipulator 221, e.g. an implementation of the robotic manipulator 121 described in previous examples. In accordance with such examples, the robotic manipulator 221 includes a robotic arm 220, an end effector 222, and a motion subsystem 230. The motion subsystem 230 is communicatively coupled to the robotic arm 220 and end effector 222 and configured to cause the robotic arm 220 and/or end effector 222 to move in accordance with actuation commands or control signals issued by a controller (not shown). The controller, e.g. controller 110 described in previous examples, is part of a manipulator apparatus with the robotic manipulator 221.

The robotic manipulator 221 is arranged to manipulate an object, e.g. grasped by the end effector 222, in the workspace to pack the object into a receiving space, e.g. a container (or “bin” or “tote”) 244. For example, the robotic packing system 200 may be implemented in an automated storage and retrieval system (ASRS), e.g. in a picking station thereof. An ASRS typically includes multiple containers arranged to store items and one or more load-handling device or automated guided vehicle (AGV) to retrieve one or more containers 244 during fulfilment of a customer order. At a picking station, items are picked from and/or placed into the one or more retrieved containers 244. The one or more containers in the picking station may be considered as being storage containers or delivery containers. A storage container is a container which remains within the ASRS and holds eaches of products which can be transferred from the storage container to a delivery container. A delivery container is a container that is introduced into the ASRS when empty and that has a number of different products loaded into it. A delivery container may comprise one or more bags or cartons into which products may be loaded. A delivery container may be substantially the same size as a storage container. Alternatively, a delivery container may be slightly smaller than a storage container such that a delivery container may be nested within a storage container.

The robotic packing system 200 can therefore be used to pick an item from one container, e.g. a storage container, and place the item into another container, e.g. a delivery container, at a picking station. The picking station may thus have two sections: one section for the storage container and one for the delivery container. The arrangement of the picking station, e.g. the sections thereof, can be varied and selected by the skilled person. For example, the two sections may be arranged on two sides of an area or with one section above or below the other. In some cases, the picking station is located away from the storage locations of the containers in the ASRS, e.g. away from the storage grid in a grid-based ASRS. The load handling devices may therefore deliver and collect the containers to/from one or more ports of the ASRS which are linked to the picking station, e.g. by chutes. In other instances, the picking station is located to interact directly with a subset of storage locations in the ASRS, e.g. to pick and place items between containers located at the subset of storage locations. For example, in the case of a grid-based ASRS, the picking station may be located on the grid of the ASRS.

The robotic manipulator 221 may comprise one or more end effectors 222. For example, the robotic manipulator 221 may comprise more than one different type of end effector. In some examples, the robotic manipulator 221 may be configured to exchange a first end effector for a second effector. In some cases, the controller may send instructions to the robotic manipulator 221 as to which end effector 222 to use for each different object or product (or stock keeping unit, “SKU”) being packed. Alternatively, the robotic manipulator 221 may determine which end effector to use based on the weight, size, shape etc. of a product. Previous successes and/or failures to grasp and move an item may be used to update the selection of an end effector for a particular SKU. This information may be fed back to the controller so that the success/failure information can be stored and shared between different picking/packing stations. A robotic manipulator 221 may be able to change end effectors. For example, the picking/packing station may comprise a storage area which can receive one or more end effectors. The robotic manipulator 221 may be configured such that an end effector in use can be removed from the robotic arm 220 and placed into the end effector storage area. A further end effector may then be removably attached to the robotic arm 220 such that it can be used for subsequent picking/packing operations. The end effector may be selected in accordance with planned picking/packing operations.

The robotic packing system 200 of FIG. 2 includes a camera 216 positioned above the workspace of the robotic manipulator 221. The overhead camera 216 is supported by a frame structure 240, which is shown in a simplified form in the drawing but could take any suitable structural form as will be appreciated by the skilled person. For example, the frame structure 240 may comprise a scaffold on which the overhead camera 216 is mounted.

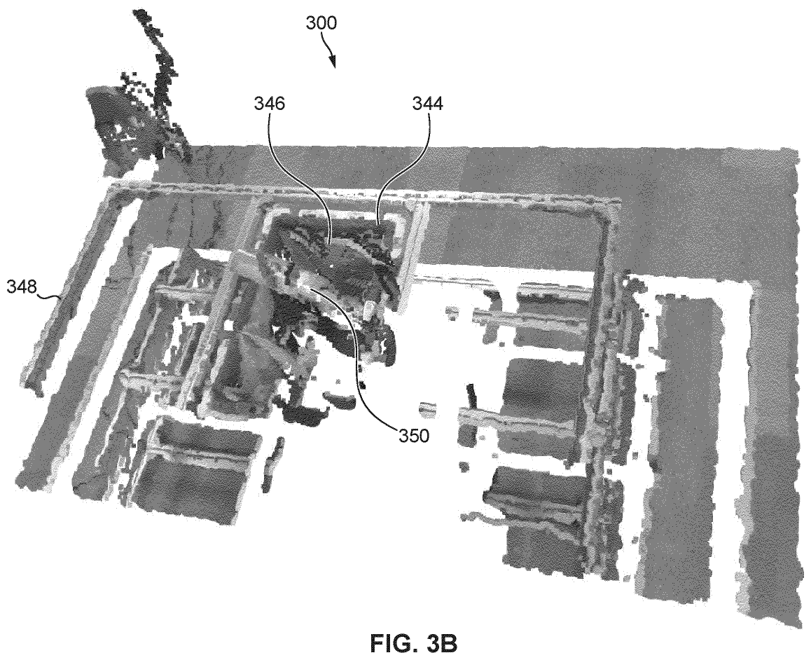

The overhead camera 216 is arranged to capture an image of an object grasped by the end effector 222 of the robotic manipulator 221. For example, the overhead camera 216 is arranged such that it has a view of the workspace of the robotic manipulator 221 including the object when grasped by the end effector 222. FIG. 3A shows schematic representation of the workspace of the robotic manipulator 221 as viewed by the overhead camera 216. The workspace includes the receiving space, e.g. the container 344, into which the robotic manipulator 221 is arranged to pack the grasped object. In this example, the container 344 is positioned in a rig 348 arranged to support the container 344 at a particular location in the workspace of the robotic manipulator 221. As previously described, the container 344 may be located at a picking station, or at a storage location in a grid structure, of a grid-based ASRS in other examples.

The camera 216 may correspond to the one or more cameras or imagers 116 in the sensor subsystem 114 of the robotic packing system 100 described with reference to FIG. 1. In examples, the camera 216 of the robotic packing system 200 comprises a depth camera configured to capture depth images. For example, a depth (or “depth map”) image includes depth information of the scene viewed by the camera 216.

A point cloud generator may be associated with the overhead camera or imager 216, e.g. depth camera or LIDAR sensor, positioned to view the workspace thereunder, e.g. the container 244 and its contents. In a typical setup, the lower surface of the container 244 is arranged horizontally (e.g. in the x-y plane per FIG. 2) with the sensors of the overhead camera or imager 216 facing vertically down (e.g. in the −z direction per FIG. 2) to view the contents of the container 244. Examples of structured light devices for use in point cloud generation include Kinect™ devices by Microsoft®, time of flight devices, ultrasound devices, stereo camera pairs and laser stripers. These devices typically generate depth map images.

In the art, it is usual to calibrate depth map images for aberrations in the lenses and sensors of the camera. Once calibrated, the depth map can be transformed into a set of metric 3D points, known as a point cloud. Preferably, the point cloud is an organised point cloud which means that each three-dimensional point lies on a line of sight of a distinct pixel resulting in a one-to-one correspondence between 3D points and pixels. Organisation is desirable because it allows for more efficient point cloud processing. In a further part of the calibration process the pose of the camera, namely its position and orientation, relative to a reference frame of the robotic packing system 200 or robotic manipulator 221, is determined. The reference frame may be the base of the robotic manipulator 221, however, any known reference frame will work, e.g. a reference frame situated at a wrist joint of the robot arm 220. Accordingly, a point cloud may be generated based on a depth map and information about the lenses and sensors used to generate the depth map. Optionally, the generated depth map may be transformed into the reference frame of the robotic packing system 200 or robotic manipulator 221. For simplicity, the camera or imager 116, 216 is shown as a single unit in FIGS. 1 and 2. However, as will be appreciated, each of the functions of depth map generating and depth map calibration could be performed by separate units, for example, the depth map calibration means could be integrated in the controller of the robotic packing system 100, 200.

FIG. 3B shows an example depth image 300 of the workspace of the robotic manipulator 221, corresponding to the view in FIG. 3A, as captured by the overhead camera 216. The depth image 300 comprises a point cloud in this example. Included in the image 300 are the rig 348, the container 344, bags (e.g. grocery or carrier bags) 346 in the container 344, and the object 350 grasped by the end effector 222 of the robotic manipulator 221.

A controller for the robotic manipulator 221, e.g. the controller 100 communicatively coupled to the manipulator apparatus of previous examples, is configured to obtain the image 300 captured by the overhead camera 216. As described herein, the image 300 includes the object 350 grasped by the end effector 222 of the robotic manipulator 221.

The controller processes the image 300 to determine a major axis of the object 350, e.g. a longitudinal axis of the object 350, in the image 300. For example, the longitudinal axis of the object 350 is an axis along the lengthwise direction of the body of the object which may pass through the centre of gravity or centre of mass. The major axis can also be defined by endpoints of the longest line that can be drawn through the object 350 represented in the image 300. The major axis endpoints, e.g. pixel coordinates (x₁,y₁) and (x₂,y₂) in the image 300, are found by computing the pixel distance between every combination of border pixels in the object boundary and finding the pair with the maximum length, for example.

The object 350 may have other axes substantially unequal in length to the longitudinal axis, e.g. a minor axis or transverse axis. The minor axis is defined by endpoints of the longest line that can be drawn through the object 350 represented in the image, while remaining perpendicular to the major axis, for example. The minor axis endpoints are determined by computing the pixel distance between two border pixel endpoints, for example. The transverse axis is perpendicular to the longitudinal axis. In the third dimension, the sagittal axis may be defined which is perpendicular to both the longitudinal axis and the transverse axis of the object 350. An object which is symmetrical in two or three dimensions will have two or three respective axes substantially equal in length, for example. For example, a spherical object has symmetry in all three dimensions such that all axes passing through the centre of the sphere are equal in length. Any such axis may therefore be determined as the major axis of the spherical object. Similarly, a cylindrical object 350 as in the example of FIG. 3B is axisymmetric, having cylindrical symmetry about its longitudinal axis.

In examples, the controller processes the depth image 300 to remove therefrom any features with an associated depth value outside a range corresponding to a volume between the end effector 222 and uppermost plane 262 of the receiving space. For example, where the image 300 is a point cloud, the controller deletes points from the point cloud that lie between the end effector 222 and the uppermost plane 362 of the receiving space. The uppermost plane 262 of the receiving space is coincident with the top of the receiving space, e.g. the container 244 in the example of FIG. 2. In examples where the image 300 comprises depth information, e.g. a layer of depth values corresponding pixelwise to colour (such as RGB) or intensity channel data, the controller removes pixels or pixel values from the image 300 which have associated depth values outside the defined range. The controller can thus isolate the object 350 from the image 300 using the depth information.

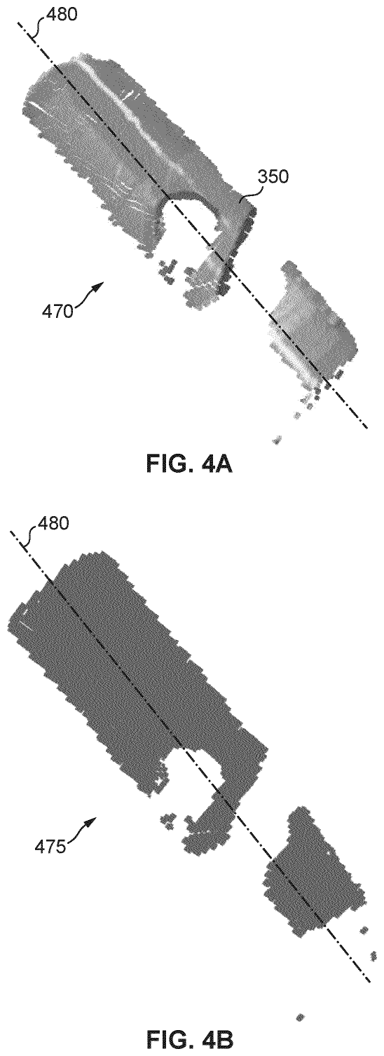

FIG. 4A shows an example image 470 of the object 350 isolated from the image 300 captured by the overhead camera 216. In examples, the controller processes the image 470 to project the depth image of the object 300 onto a plane 260 parallel to a base of the receiving space (e.g. container 244, 344) to obtain a set of two-dimensional (2D) points as shown in the example image 475 of FIG. 4B. The controller then determines the major axis 480 of the object 350 based on the set of 2D points. For example, the controller performs principal component analysis (PCA) using the set of 2D points. Performing PCA determines as the major axis 480, for example, the axis that maximises the variance of the projected 2D points onto this axis, which is more robust than using the line between the most distant points, for example, because it will not be affected by outliers (such as the few distant points in the bottom of FIG. 4B).

With the major axis 480 of the object 350 determined, the controller is configured to determine a first object pose in which the major axis 480 is aligned with an axis of a receiving space. In the example of FIG. 3B, the axis of the receiving space is a major axis of a selected bag 346 in the container 344. In examples, the major axis 480 of the object and the axis of the receiving space are aligned when they are substantially parallel to each other, e.g. within one or two degrees of angular separation. For example, the two axes do not need to be superimposed, lined up in a straight line, or overlapping in a common plane to be aligned with each other. In certain cases, a first object pose that does make the two axes at least partly overlap, when projected into a common plane, in addition to aligning the axes is determined. However, subsequent initial object poses corresponding to further packing attempts (described in later examples) may keep the axes aligned but shift the major axis 480 of the object such that the two axes no longer overlap each other.

An object pose represents a position and orientation of the associated object in space. For example, a six-dimensional (6D) pose of the object includes respective values in three translational dimensions (e.g. corresponding to a position) and three rotational dimensions (e.g. corresponding to an orientation) of the object.

In some implementations, the controller works with a pose generator (or pose estimator) configured to generate (e.g. determine or estimate) object poses. For example, determining a given object pose involves mapping two-dimensional pixel locations in the image of the object to a six-dimensional pose.

The controller controls the robotic manipulator 221 to manipulate the object to the first object pose above the receiving space, e.g. container 244. For example, the controller issues actuation commands or control signals to the motion subsystem 230 of the robotic manipulator 221 to cause the robotic arm 220 and/or end effector 222 to manipulate, e.g. move and/or rotate, the object to the first object pose. In certain instances, the controller determines a planar rotation of the end effector 222 to align the major axis of the object with the axis of the receiving space, e.g. in the first object pose. The controller may then control the robotic manipulator 221 to perform the planar rotation of the end effector 222.

In examples, the first object pose comprises a predetermined value for the height of the object, e.g. in a z-direction normal to a base of the receiving space (such as container 244). For example, the first object pose comprises a translational position lying in a plane 264 above the container 244, where the plane 264 is perpendicular to the z-direction, i.e. parallel to the lowermost plane 260 or uppermost plane 262 of the container 244. The x-y position of the first object pose may be selected to be inside the x-y bounds of the container 244, for example. In some cases, the first object pose for attempting placement may be determined by adjusting the x-y position of an initial object pose (e.g. determined based on the axis alignment) relative to the receiving space, e.g. shifting the x-y position of the initial object pose towards the centre of the container 244. For example, the initial object pose may have the object overhanging beyond the x-y bounds of the container 244, in response to which the initial object pose is adjusted such that less of the object overhangs beyond the container 244 (or more of the object area overlays the container area). In terms of orientation (again relative to the global frame of reference shown in FIG. 2), the first object pose may be determined by the controller keeping the roll and pitch angles for the object stable, while changing the yaw angle to achieve alignment of the respective axes.

The controller controls the robotic manipulator 221 to move the object from the first object pose down into the receiving space. For example, with the orientation of the object defined by the first object pose, the controller controls the robotic manipulator 221 to move the object in the (negative) z-direction towards and into the container 244, e.g. by adjusting the z-value of the first object pose while maintaining the other values of the first object pose. For example, the x-y position and orientation of the object is kept the same by the robotic manipulator 221 while the z-value of the object's pose is altered as the robotic manipulator 221 moves the object down into the container 244.

The robotic manipulator 221 includes at least one force sensor (not shown). For example, the robotic manipulator 221 includes at least one of a torque sensor to detect torque forces, and a linear force sensor to detect linear forces, acting on the robotic manipulator 221—e.g. at the robotic arm 220 or end effector 222. The force/torque sensor is installed between the robotic arm 220 and the end effector 222, for example.

There are several types of force/torque sensors selectable by the skilled person, including strain gauge, capacitive, and optical sensors. The working principle of any force sensor is to generate a measurable response to the applied force. Some force sensors are created with the use of force-sensing resistors, e.g. using electrodes and sensing polymer film. Force-sensing resistors are based on contact resistance: the conductive polymer film changes its electrical resistance in a predictable way under a force applied on its surface. In certain implementations, the robotic manipulator 221 has a built-in force/torque sensor—for example, an e-Series industrial robot (e.g. UR3e, UR5e, UR10e) manufactured by Universal Robots A/S of Odense, Denmark may be used with its built in force/torque sensor. Additionally or alternatively, the robotic manipulator 221 may be retrofitted with the at least one force/torque sensor—for example, a HEX force/torque sensor manufactured by OnRobot A/S of Odense, Denmark.

During the attempt to pack the object by pushing the object down into the receiving space, unexpected contacts can occur with the receiving space, components thereof, or objects already packed in the receiving space. For example, referring to FIGS. 3A-3B where the receiving space corresponds to a bag within the tote 344, the unexpected contacts can occur with the tote, bag edges, or objects already inside the tote 344 or bag 346.

A predetermined force threshold is set for contact forces detected by the force/torque sensor. If a contact force at the end effector 222 is detected that is above the predetermined force threshold, the controller controls the robotic manipulator 221 to manipulate the object to a different, second, object pose above the receiving space for initiating a further attempt to pack the object. For example, once a detected contact force is too high (relative to a preset force/torque threshold) the controller causes the robotic manipulator 221 to reinitialise the object for attempting to pack the object again, but starting from another initial object pose. In examples, the normal of the detected force or torque signal is compared to the preset force or torque threshold value. In certain cases, there are separate force and torque thresholds such that the normal of the detected force and torque signals are compared to the respective force and torque threshold values.

The force/torque threshold values may be predetermined manually, e.g. by testing whether the system is sensitive enough to collisions occurring, versus being oversensitive, with a given force/torque threshold value. In some cases, only the difference between the measured force/torque values and corresponding “pre-packing” values, set before commencement of packing, are considered in order to account for sensor bias that drifts over time.

In some cases, different thresholds are used for different SKU categories: for example, a more sensitive threshold may be used for a bag of crisps, compared to other SKUs, to reduce the likelihood of damage to its contents while packing.

In examples, the first and second object poses lie in a common plane 264 parallel to an uppermost plane 262 or base plane 260 of the receiving space, e.g. container 244. For example, the controller reinitialises the robotic manipulator 221 to position the object at a predetermined height above the receiving space, but shifts the object's position (and therefore pose) in the plane 264 at each reinitialisation. Such shifting of the object's pose in this initialisation plane 264 may be done according to a predetermined path or route in the plane, e.g. a spiral, figure of eight, or linear path like a zig-zag toolpath. The predetermined path defines, for example, a series of pose displacements between subsequent poses in the path. The robotic manipulator 221 may thus iterate along the predetermined path following each packing attempt until the object is successfully packed in the receiving space. For example, in the case of a spiral path, each time a packing attempt fails, a different dimension of the initial object position in the plane 264 is modified, in such way that the series of positions of the end-effector describes a spiral in the plane 264, with the orientation of the object also being modified in alternate directions between packing attempts.

A successful packing attempt occurs, for example, when the controller determines that the object 350 and the end effector 222 are positioned within the receiving space 244, 344 without detecting a contact force above the set force threshold. For instance, the pose of the end-effector can be determined, e.g. by the controller, from forward kinematics techniques that will be known to the skilled person. In short, the pose of the end effector 222 at the end of the robotic arm 220 can be determined using information of all the joint positions of the robotic manipulator 221 (given by the robot sensors) and knowing all the relations between the links of the robotic arm 220. The controller can then determine if the positional (x, y, z) coordinates of the end effector 222 are located inside the receiving space 244, 344, e.g. a volume region defined by the boundaries of the receiving space such as a tote.

Upon the controller determining a successful packing attempt, the controller causes the end effector 222 to release the object 350 in the receiving space 244, 344, e.g. by issuing actuation commands or control signals to the motion subsystem 230 of the robotic manipulator 221. After releasing the object 350, the robotic manipulator 221 may return to a reset position above the receiving space, e.g. ready to perform another picking and/or packing task.

In some examples, during a packing attempt, the force/torque sensor detects a contact force and the controller determines, in response thereto, a direction away from the contact point where the contact force is detected. For example, the controller determines a normal force vector upon detection of a contact force above the set threshold. The controller further controls the robotic manipulator 221 to move the end effector 222 and object in the determined direction away from the contact point, e.g. along the determined normal vector. Thus, the controller can use the force and/or torque feedback to reduce damage to the object being packed, and any other objects already inside the receiving space, when aborting the packing attempt. The selection of the second object pose may also be based on the determined direction away from the contact point. For example, if a contact point is detected to the right of the end effective, the next initiation pose for the subsequent packing attempt may be shifted to the left to move the end effector 222 away from the area where the unexpected contact occurred. In examples where the subsequent initial object poses are based on a predetermined path, the next initiation pose may be selected from the predetermined path of poses while also being in a direction (e.g. projected in the initialisation plane 264) away from the contact point. Furthermore, the information about any detected contact points in previous packing attempts can be used in a subsequent packing attempt, e.g. to alter the route of the end effector 222 through the receiving space 244 to avoid the same contact(s) occurring during the packing attempt.

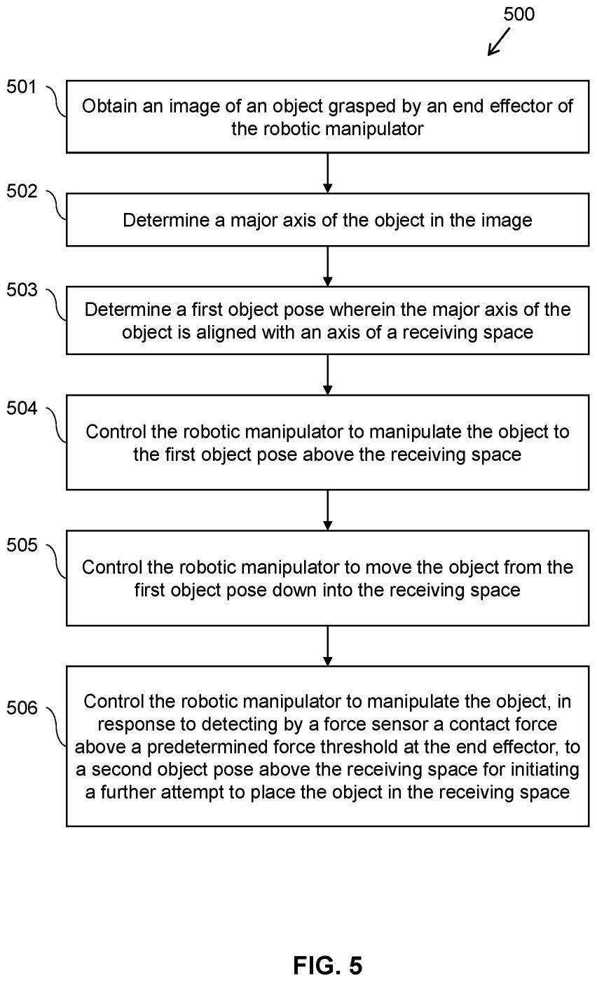

FIG. 5 shows a computer-implemented method 500 of controlling a robotic manipulator for packing an object. The robotic manipulator may be one of the example robotic manipulators 121, 221 described with reference to FIGS. 1 and 2. The method 500 may be performed by one or more components of the packing system 100 previously described, for example the control system 108 or controller 110.

At 501, an image of an object grasped by an end effector of the robotic manipulator is obtained. In some examples, the image comprises a depth image. In certain cases, the method 500 includes removing from the depth image any features (e.g. points in a point cloud, or pixels in an image with depth values) which have an associated depth value outside a range between respective depth values of the end effector and uppermost plane of the receiving space. Such a removal of features isolates the object in the image, since only the object grasped by the end effector is positioned between the end effector and the top of the receiving space, e.g. container or tote. Depending on the type of depth image, the features removed from the image may comprise pixels or points in a point cloud.

At 502, a major axis of the object in the image is determined. In some cases, the depth image of the object is projected onto a plane parallel to a base of the receiving space to flatten the image into 2D points. The major axis of the object can then be determined from the flattened image, e.g. using PCA with the set of 2D points.

At 503, a first object pose is determined, in which the major axis of the object is aligned with an axis of a receiving space. For example, a rotation of the end effector is determined which would align the major axis of the object with the axis of a receiving space. The axis of the receiving space may be the major axis thereof, or another axis such as a minor axis perpendicular to the major axis. The rotation may be determined based on a calculated angle between the object's major axis and the axis of the receiving space. For example, the rotation corresponds to an angular displacement which would reduce the angle between the two axes to zero such that they are aligned.

In examples, spatial dimensions of the object are determined based on the obtained image of the object. For example, an area of the object in the projection of 2D points is determined. Spatial dimensions of the receiving space are also obtained, e.g. as input parameters or likewise determined based on an image comprising the receiving space. The first object pose, for attempting placement of the object into the receiving space, may be determined based on a comparison of the spatial dimensions of the object and the spatial dimensions of the receiving space. For example, an initial pose of the object may be determined from the axis alignment step and then adjusted based on the spatial dimensions comparison. If, in the initial pose, the object overhangs (e.g. protrudes beyond) the boundaries of the receiving space (e.g. a container and/or a bag within the container), the initial pose may be adjusted to reduce the overhang. For example, in the 2D projected image, a determined overhang area of the object beyond an edge of the receiving space can be reduced by shifting the initial pose towards the centre of the receiving space. In some cases, an adjustment vector for shifting the initial object pose is computed per edge of the receiving space that the object overhangs. A resultant adjustment vector can then be computed by summing the individual component adjustment vectors. In cases where the object overhangs opposite edges of the receiving space, the resultant adjustment vector applied to the initial object pose may be computed to evenly distribute the overhang on both sides of the receiving space, e.g. to centre the object with respect to the receiving space along the axis on which the double overhang occurs.

In some examples, the determined first object pose is adjusted based on a determined end effector pose. For example, the end effector pose can be calculated based on forward kinematics, as referenced above. If the end effector pose lies outside of the boundaries of the receiving space at the determined first object pose, the first object pose can be adjusted, e.g. shifted, to move the corresponding end effector pose to, or within, an edge of the receiving space, for example. Thus, for the first attempt of placing the object within the receiving space, the end effector is positioned at least above an edge of, if not within, the receiving space. This can improve the likelihood of the object being placed within the receiving space, e.g. instead of falling outside the receiving space after release by the end effector.

At 504, the robotic manipulator is controlled to manipulate the object to the first object pose above the receiving space. For example, control signals are sent to a motion subsystem of the robotic manipulator to perform the determined rotation of the end effector and align the major axis of the object with the relevant axis of the receiving space. The manipulation of the object to the first object pose may additionally, or alternatively, include a translational motion. In some cases, the determined rotation to align the relevant axes is a planar rotation (e.g. determined in a plane parallel to the base of the receiving space) and the manipulation to put the object in the first object pose may additionally include a rotation in a different plane.

At 505, the robotic manipulator is controlled to move the object from the first object pose down into the receiving space. For example, the height of the object above the receiving space, e.g. in the z-direction shown in FIG. 2, is decreased to move the object into the receiving space, e.g. crossing the uppermost plane 262 of the container 244. The z-component of the object's pose may be changed while the other components (e.g. five for a 6D object pose) are kept constant.

At 506, the robotic manipulator is controlled to manipulate the object in response to detecting by a force sensor a contact force above a predetermined force threshold at the end effector. In such an instance, the object is manipulated to a second object pose above the receiving space for initiating a further attempt to place the object in the receiving space.

In some examples, the first and second object poses lie in a common plane parallel to an uppermost or lowermost plane of the receiving space. A displacement of the second object pose relative to the first object pose in the common plane may be determined according to a predetermined path of pose displacements. For example, the robotic manipulator is controlled to iterate manipulation of the object in the common plane, along the predetermined path, in response to each failed placement attempt, i.e. when a contact force above the predetermined threshold is detected. After a failed packing attempt, the robotic manipulator is controlled to return the object to the common plane, e.g. an initialisation plane, but shift the position of the object in the plane according to the predetermined path, e.g. a series of initialisation positions.

Upon determining that the object and the end effector are positioned within the receiving space, without detecting a contact force above the predetermined force/torque threshold, the end effector is controlled to release the object in the receiving space. For example, control signals are sent to the motion subsystem of the robotic manipulator to cause the end effector to release its grip on the object. The robotic manipulator may then return to a reset position, e.g. in the initialisation plane above the receiving space or another predetermined position, ready to perform another task.

The method 500 of controlling a robotic manipulator for packing an object can be implemented by a control system or controller for a robotic manipulator, e.g. the control system or controller of the packing system 100 previously described. For example, the control system or controller includes one or more processors to carry out the method 500 in accordance with instructions, e.g. computer program code, stored on a computer-readable data carrier or storage medium.

The above examples are to be understood as illustrative examples. Further examples are envisaged. For instance, the robotic manipulator 221 may further include one or more cameras mounted on the robotic arm 220. A camera may be mounted on, or near to, the end effector, e.g. on or near the wrist of the robotic arm. Additionally, or alternatively, a camera may be mounted on or near to the elbow of the robotic arm. The use of a camera, or cameras, mounted on the robotic arm may be in addition or an alternative to the overhead camera 216 of the robotic packing system. Each camera may be provided with lighting elements to illuminate the interior of a container when an item is being packed. One or more cameras may be located elsewhere as part of the robotic packing system. For example, a camera may be used as a barcode scanner.

Furthermore, in described examples, the object grasped by the end effector is isolated from the rest of the image using depth data, i.e. when the image comprises a depth image. In other examples, the object may be determined in the image using object detection methods, e.g. with an artificial neural network (ANN), to isolate the object and determine its major axis. In certain cases, a neural network model may be trained to determine the major axis of the object directly from the image captured by the overhead camera. Additionally, or alternatively, an ANN may be trained and implemented to reconstruct parts of the object that are missing from the images thereof due to obfuscation by the robotic manipulator, e.g. the end effector, or external structures. FIG. 4A shows missing parts of the object where part of the robotic manipulator was positioned between the object and the camera during imaging, for example. These ANN (or “deep learning”) methods could be explicit (e.g. where the ANN model provides the reconstructed point cloud) or implicit (e.g. where the major axis of the object is determinable despite part of the object not being visible, due to the generalisation of the ANN 5 being able to identify that the visible parts of the object belong to an item which is more extensive than is shown in the image).

It is also to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

1. A computer-implemented method of controlling a robotic manipulator for packing an object, the method comprising:
obtaining an image of an object grasped by an end effector of the robotic manipulator;
determining a major axis of the object in the image;
determining a first object pose wherein the major axis of the object is aligned with an axis of a receiving space; and
controlling the robotic manipulator to:
manipulate the object to the first object pose above the receiving space;
move the object from the first object pose down into the receiving space; and
manipulate the object, in response to detecting by a force sensor a contact force above a predetermined force threshold at the end effector, to a second object pose above the receiving space for initiating a further attempt to place the object in the receiving space.

2. A computer-implemented method according to claim 1, comprising controlling the robotic manipulator, in response to determining that the object and the end effector are positioned within the receiving space without detecting a further contact force above the predetermined force threshold, to release the object from the end effector.

3. A computer-implemented method according to claim 1, wherein the first and second object poses lie in a common plane parallel to an uppermost plane of the receiving space.

4. A computer-implemented method according to claim 3, wherein a displacement of the second object pose relative to the first object pose in the common plane is determined according to a predetermined path of pose displacements.

5. A computer-implemented method according to claim 1, comprising:
determining, in response to detecting the contact force by the force sensor, a direction away from a contact point associated with the detected contact force; and
controlling the robotic manipulator to move the end effector and object in the determined direction away from the contact point.

6. A computer-implemented method according to claim 1, wherein the image comprises a depth image.

7. A computer-implemented method according to claim 6, comprising removing from the depth image any features with an associated depth value outside a range corresponding to a volume between the end effector and uppermost plane of the receiving space.

8. A computer-implemented method according to claim 6, comprising projecting the depth image onto a plane parallel to a base of the receiving space to obtain a set of two-dimensional points.

9. A computer-implemented method according to claim 8, wherein determining the major axis of the object in the image is done based on the set of two-dimensional points.

10. A computer-implemented method according to claim 9, wherein determining the major axis of the object in the image is done by performing Principal Component Analysis using the set of two-dimensional points.

11. A computer-implemented method according to claim 1, wherein controlling the robotic manipulator to manipulate the object to the first object pose comprises:
determining a planar rotation of the end effector to align the major axis of the object with the axis of the receiving space; and
controlling the robotic manipulator to perform the planar rotation of the end effector.

12. A computer-implemented method according to claim 1, comprising:
determining spatial dimensions of the object based on the image;
obtaining spatial dimensions of the receiving space; and
determining the first object pose based on a comparison of the spatial dimensions of the object and the spatial dimensions of the receiving space.

13. A computer-implemented method according to claim 12, wherein determining the first object pose comprises adjusting an initial object pose to reduce a determined overhang of the spatial dimensions of the object beyond the spatial dimensions of the receiving space.

14. A computer-implemented method according to claim 1, comprising:
determining an end effector pose of the end effector; and
adjusting the first object pose based on the end effector pose.

15. A computer program comprising instructions which, when the program is executed by a computer, cause the computer to carry out the computer-implemented method of claim 1.

16. A computer-readable data carrier having stored thereon the computer program of claim 15.

17. A controller for a robotic manipulator, wherein the controller is configured to perform the computer-implemented method of claim 1.

18. A robotic packing system comprising the controller of claim 17 and the robotic manipulator for packing an object.
